(19) United States
(12) Patent Application Publication
(10) Pub. No.: US 2018/0158391 A1
(43) Pub. Date: Jun. 7, 2018

(54) DRIVING METHOD, DRIVING DEVICE AND IN-CELL TOUCH SCREEN

(71) Applicant: Wuhan China Star Optoelectronics Technology Co., Ltd., Wuhan, Hubei (CN)

(72) Inventors: Man LI, Shenzhen, Guangdong (CN); Feilin JI, Shenzhen, Guangdong (CN); Wei CHEN, Shenzhen, Guangdong (CN)

(73) Assignee: Wuhan China Star Optoelectronics Technology Co., Ltd., Wuhan, Hubei (CN)

(21) Appl. No.: 15/118,879

(22) PCT Filed: Jun. 27, 2016
(86) PCT No.: PCT/CN2016/087252

§ 371 Date: Aug. 13, 2016

(30) Foreign Application Priority Data
May 26, 2016 (CN) 201610362191.5

(51) Int. Cl. G09G 3/20; G06F 3/041

(52) U.S. Cl. CPC G09G 3/2007; G06F 3/0412; G09G 2320/0276; G09G 2320/0233; G09G 2320/0214

(57) ABSTRACT

The present application discloses a driving method, a driving device and an in-cell touch screen, wherein the driving method including setting a first and a second Gamma value of the in-cell touch screen, wherein the first Gamma value is greater than the second Gamma value; dividing the display period of each frame into a display and a touch period; and if the touch operation detected by the in-cell touch screen meets the predetermined condition: in the display period, determining a first gray scale voltage based on the first Gamma value, and input the first gray scale voltage to a data signal line; in the touch period, determining a second gray scale voltage based on the second Gamma value, and input the second gray scale voltage to the data signal line of the in-cell touch screen to compensate for the brightness loss, and increase the uniformity and the visual experience.

### CROSS REFERENCE

This application claims the priority of Chinese Patent Application No. 201610362191.5, entitled “DRIVING METHOD, DRIVING DEVICE AND IN-CELL TOUCH SCREEN”, filed on May 26, 2016, the disclosure of which is incorporated herein by reference in its entirety.

### FIELD OF THE INVENTION

The present application relates to a display technology field, and more particularly to a driving method, driving device and in-cell touch screen.

### BACKGROUND OF THE INVENTION

With the rapid development of display technology, the touch screen has been widely used for a variety of terminals. Wherein the Full In-Cell touch screen is kind of an in-cell touch screen that fully integrated touch electrode to the liquid crystal cell, with a thin, low-cost advantages. However, if the touch scanning of the Full In-Cell touch screen and display scanning working simultaneously, the display function and the touch function are easy to interfere with each other. To solve this problem, the time-dividing driving method is generally used for the conventional technology; the period unit is divided into display period subunit and touch period subunit respectively to perform the display scanning and the touch scanning.

In the scanning period of the touch scanning, the Thin Film Transistor, TFT in the pixel should be closed to maintain the display by capacitive effect of the liquid crystal. However, because of the process issue in fact, the pixels have leakage current, when the leakage current reaches a certain level, the TFT in the pixel can be turn on, and a leakage pathway from the liquid crystal capacitor to the source electrode of the TFT is formed. Leakage will cause loss of brightness of the pixels, so that in display the same frame, the brightness of the display period and the touch period is inconsistent, thereby reducing the display quality and viewing experience.

### SUMMARY OF THE INVENTION

The embodiment of the present application discloses a driving method, a driving device and an in-cell touch screen to increase the uniformity of the display brightness of the in-cell touch screen and the visual experience.

The first aspect of the embodiment of the present application discloses a driving method applied in the in-cell touch screen, the driving method includes:

setting a first Gamma value and a second Gamma value of the in-cell touch screen, wherein the first Gamma value is greater than the second Gamma value;

dividing the display period of each frame into a display period and a touch period;

if the touch operation detected by the in-cell touch screen meets the predetermined condition:

in the display period, determining a first gray scale voltage based on the first Gamma value, and input the first gray scale voltage to a data signal line of the in-cell touch screen;

in the touch period, determining a second gray scale voltage based on the second Gamma value, and input the second gray scale voltage to the data signal line of the in-cell touch screen.

As a possible embodiment, the predetermined condition includes: within a predetermined period, the frequency of the touch operation detected by the in-cell touch screen is between the first threshold of the frequency and the second threshold of the frequency, wherein the first threshold of the frequency is less than the second threshold of the frequency.

As a possible embodiment, the driving method further includes:

within a predetermined period, the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

As a possible embodiment, the driving method further includes:

within a predetermined period, the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

As a possible embodiment, the driving method further includes: storing the first gray scale voltage-transmittance curve and the second gray scale voltage-transmittance curve in advance;

determining the first gray scale voltage according to the first Gamma value, the specific is: determining the first transmittance according to the first Gamma value corresponding to the Gamma curve, and determining the first gray scale voltage according to the first transmittance and the first gray scale voltage-transmittance curve; and

determining the second gray scale voltage according to the second Gamma value, the specific is: determining the second transmittance according to the second Gamma value corresponding to the Gamma curve, and determining the second gray scale voltage according to the second transmittance and the second gray scale voltage-transmittance curve.

The second aspect of the embodiment of the present application provides a driving device, applied in an in-cell touch screen, wherein the driving device includes:

a setting unit, used for setting a first Gamma value and a second Gamma value of the in-cell touch screen, wherein the first Gamma value is greater than the second Gamma value;

a dividing unit, used to divide the display period of each frame into a display period and a touch period; and

a determination unit, used to determine if the touch operation detected by the in-cell touch screen meets the predetermined condition:

in the display period, determining a first gray scale voltage based on the first Gamma value, and input the first gray scale voltage to a data signal line of the in-cell touch screen;

in the touch period, determining a second gray scale voltage based on the second Gamma value, and input the second gray scale voltage to the data signal line of the in-cell touch screen.

As a possible embodiment, the predetermined condition includes: within a predetermined period, the frequency of the touch operation detected by the in-cell touch screen is between the first threshold of the frequency and the second threshold of the frequency, wherein the first threshold of the frequency is less than the second threshold of the frequency.

As a possible embodiment, the determination unit is further used for:

within a predetermined period, the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

As a possible embodiment, the determination unit is further used for:

within a predetermined period, the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

As a possible embodiment, the driving device further includes:

a storage unit used for storing the first gray scale voltage-transmittance curve and the second gray scale voltage-transmittance curve in advance;

the determination unit is specific used to determine the first transmittance according to the first Gamma value corresponding to the Gamma curve, determining the first gray scale voltage according to the first transmittance and the first gray scale voltage-transmittance curve; or determine the second transmittance according to the second Gamma value corresponding to the Gamma curve, determining the second gray scale voltage according to the second transmittance and the second gray scale voltage-transmittance curve.

The third aspect of the embodiment of the present application provides an in-cell touch screen, includes a liquid crystal panel and one of the driving device described in the first or the second aspects of the possible embodiment of the present application.

The embodiments of the present application sets the first Gamma value and the Gamma second value for the in-cell touch screen, wherein the first Gamma value is greater than the second Gamma value; the display period of each frame is divided into a display period and a touch period; if the touch operation detected by the in-cell touch screen meets the predetermined condition, in the display period, determining a first gray scale voltage based on the first Gamma value, and input the first gray scale voltage to the data signal line of the in-cell touch screen, in the touch period, determining a second gray scale voltage based on the second Gamma value, and input the second gray scale voltage to the data signal line of the in-cell touch screen. By adapting the present embodiment of the application, with the two sets of the predetermined Gamma value makes the transmittance of the touch period is higher than the transmittance of the display period to compensate the brightness loss of the touch period due to the current leakage and thereby increase the uniformity of the display brightness and the visual experience of the in-cell touch screen.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a schematic process flow diagram of the driving method according to an embodiment of the present application;

FIG. 2 is a schematic process flow diagram of the driving method according to an embodiment of the present application;

FIG. 3 is a relationship diagram of the first Gamma value and the second Gamma value separately corresponding to the Gamma curves according to an embodiment of the present application;

FIG. 4 is a relationship diagram of the first gray scale voltage-transmittance curve and the second gray scale voltage-transmittance curve according to an embodiment of the present application;

FIG. 5 is a schematic structure of a driving device according to an embodiment of the present application;

FIG. 6 is a schematic structure of a driving device according to another embodiment of the present application; and

FIG. 7 is a schematic structure of an in-cell touch screen according to an embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

A driving method, a driving device and an in-cell touch screen is provided in the embodiment of the present application to increase the uniformity of the display brightness and the visual experience of the in-cell touch screen, with reference to the following embodiments of the present application will be described in detail.

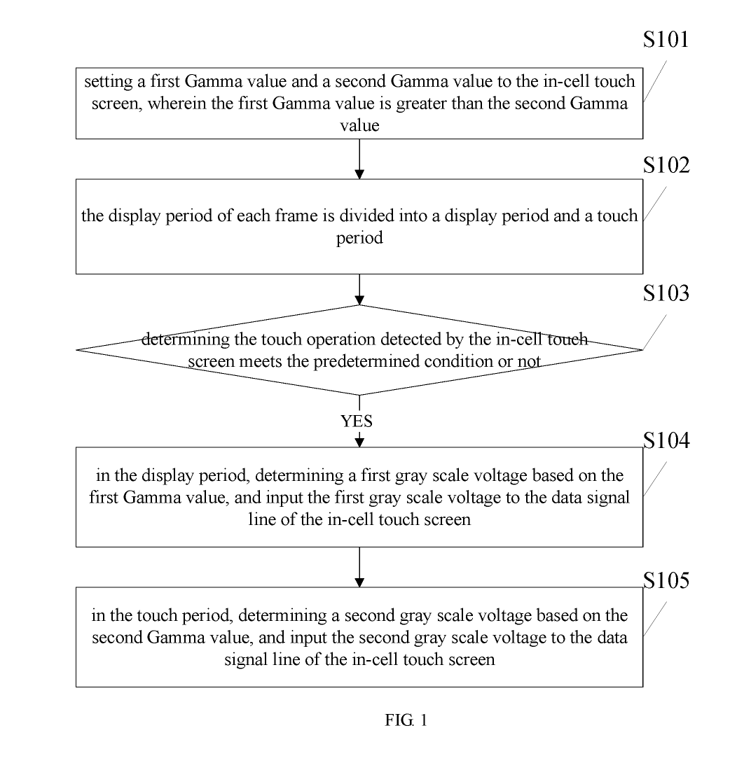

Referring to FIG. 1 is a schematic process flow diagram of the driving method according to an embodiment of the present application, wherein the driving method can be applied to the in-cell touch screen. As illustrated in FIG. 1, the driving method includes the following steps:

S101: setting a first Gamma value and a second Gamma value to the in-cell touch screen, wherein the first Gamma value is greater than the second Gamma value.

In the particular implementation, the Gamma value is set before the liquid crystal display exit the factory, each Gamma value is corresponding to a Gamma curve, Gamma curve is used to represent non-linear relationship between the gray scale level of the liquid crystal display and the transmittance. Wherein, in the same level of the gray scale, the larger the Gamma value is, the lower the corresponding transmittance.

In the conventional technology, only one Gamma value needs to be set in a liquid crystal display. In the embodiment of the present application, at least two Gamma values can be set including the first Gamma value and the second Gamma value, and the first Gamma value is greater than the second Gamma value.

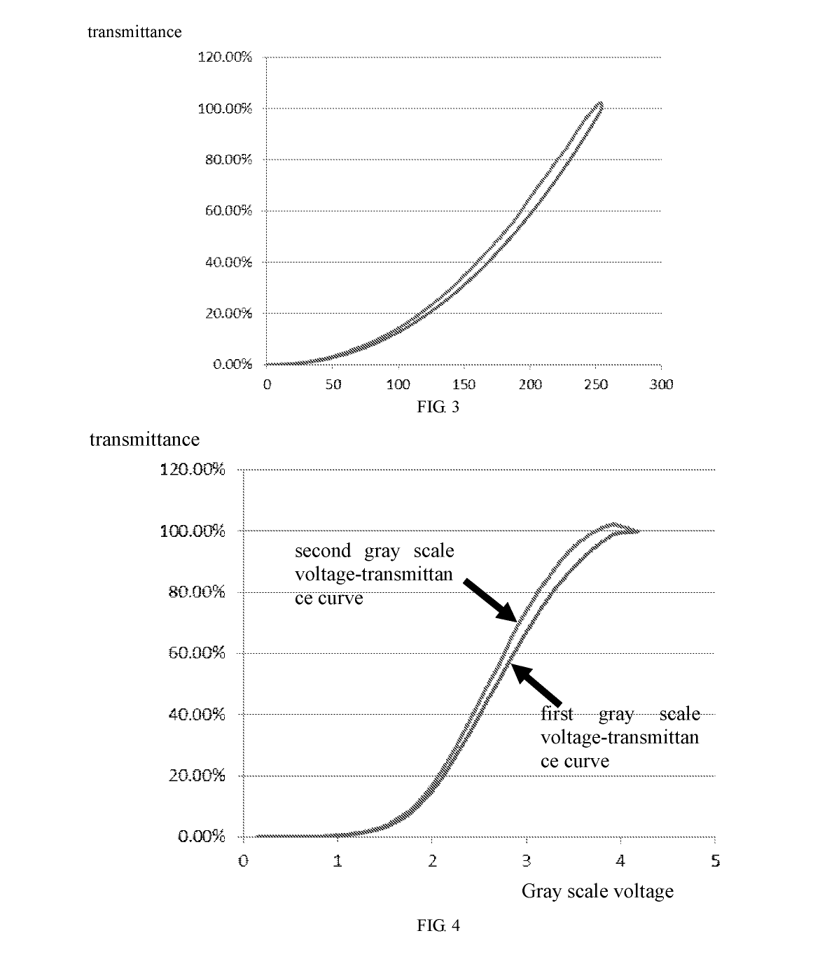

As an example of the relationship diagram of the first Gamma value and the second Gamma value separately corresponding to the Gamma curves can be referred in FIG. 3. As illustrated in FIG. 3, in the same level of the gray scale, the transmittance corresponding to the first Gamma value is lower than the transmittance corresponding to the second Gamma value.

S102: the display period of each frame is divided into a display period and a touch period.

In a specific embodiment, in the display period of one frame, the display period is the period to proceed the display scanning; the touch period is the period to proceed the touch scanning. By dividing the display period and the touch period separately at different periods, can avoid interference between each other.

Alternatively, the display period of one frame can be divided into a set or a plurality set of the display period and the touch period, for example, a display period of one frame can be divided into two sets of display period and touch period including a display period 1, touch period 1, display period 2, touch period 2. Preferably, the duration of the display period can be greater than the duration of the touch period.

S103: determining the touch operation detected by the in-cell touch screen meets the predetermined condition or not, if the judgment result is YES, proceeding step S104 and step S105.

Alternatively, to meet the predetermined condition can refer to detection the frequency or number of the touch operation within a preset range; or, can refer to detection the scene of the touch operation in a predetermined application scene such as gaming scene, photo shoot scene, text inputting scene and etc.

S104: in the display period, determining a first gray scale voltage based on the first Gamma value, and input the first gray scale voltage to the data signal line of the in-cell touch screen.

When the touch operation detected by the in-cell touch screen meets the predetermined condition, the first gray scale voltage can be determined based on the first Gamma value in the display period, and input the first gray scale voltage to the data signal line of the in-cell touch screen. Further, in the display period, a gate scanning signal can also be applied to the gate scanning line of the in-cell touch screen to perform the display scanning.

S105: in the touch period, determining a second gray scale voltage based on the second Gamma value, and input the second gray scale voltage to the data signal line of the in-cell touch screen.

When the touch operation detected by the in-cell touch screen meets the predetermined condition, the second gray scale voltage can be determined based on the second Gamma value in the touch period, and input the second gray scale voltage to the data signal line of the in-cell touch screen. Further, in the touch period, a touch scanning signal can also be applied to the touch scanning line of the in-cell touch screen to perform the touch scanning.

In a specific embodiment, the transmittance of the liquid crystal molecules of the in-cell touch screen is controlled by the gray scale voltage. By controlling the gray scale voltage, the transmittance of the liquid crystal molecules can be achieved corresponding to the transmittance of the Gamma values and the level of the gray scale. In the embodiment of the application, since the first Gamma value is greater than the second Gamma value, when the level of the gray scale is the same, the transmittance corresponding to the second Gamma value is higher than the transmittance corresponding to the first Gamma value. That is, in the display period at the same frame, the transmittance of the touch period is higher than the transmittance of the display period to compensate the brightness loss of the touch period due to the current leakage.

The driving method illustrated in FIG. 1 can be applied to the in-cell touch screen, which includes setting the first Gamma value and the Gamma second value for the in-cell touch screen, wherein the first Gamma value is greater than the second Gamma value; the display period of each frame is divided into a display period and a touch period; if the touch operation detected by the in-cell touch screen meets the predetermined condition, in the display period, determining a first gray scale voltage based on the first Gamma value, and input the first gray scale voltage to the data signal line of the in-cell touch screen, in the touch period, determining a second gray scale voltage based on the second Gamma value, and input the second gray scale voltage to the data signal line of the in-cell touch screen. By adapting the present embodiment of the application, with the two sets of the predetermined Gamma value makes the transmittance of the touch period is higher than the transmittance of the display period to compensate the brightness loss of the touch period due to the current leakage and thereby increase the uniformity of the display brightness and the visual experience of the in-cell touch screen.

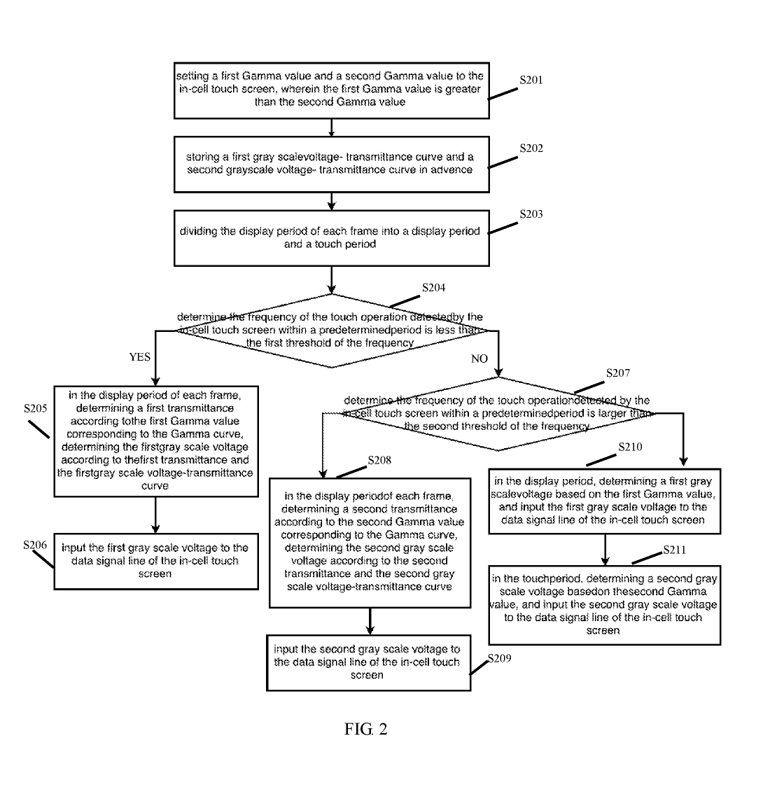

Referring to FIG. 2, FIG. 2 is a schematic process flow diagram of the driving method according to an embodiment of the present application, wherein the driving method can be applied to the in-cell touch screen. As illustrated in FIG. 2, the driving method includes the following steps:

S201: setting a first Gamma value and a second Gamma value to the in-cell touch screen, wherein the first Gamma value is greater than the second Gamma value.

In particular, the specific embodiments of step S201 can be referring to the related description of the embodiment of FIG. 1, and is not mentioned here.

S202: storing a first gray scale voltage-transmittance curve and a second gray scale voltage-transmittance curve in advance.

Wherein the Gamma value corresponding to the Gamma curve is the relationship curve between the level of the gray scale of the liquid crystal display and the transmittance. The transmittance can be determined according to the level of the gray scale and the Gamma curve. In a specific implementation, the desired transmission can be achieved by applying a suitable gray scale voltage to the data signal line. In the conventional technology, a liquid crystal display just need to set a Gamma value, by storing the Gamma value corresponding to the gray scale voltage-transmittance curve in first, the correct gray scale voltage can be determined.

In the present embodiment of the application, two gray scale voltage-transmittance curves can be stored in advance, including the first gray scale voltage-transmittance curve corresponding to the first Gamma value and a second gray scale voltage-transmittance curve corresponding to the second Gamma value.

As an example, the relationship diagram of the first gray scale voltage-transmittance curve and the second gray scale voltage-transmittance curve can be referred from FIG. 4. As illustrated in FIG. 4, under the same driving voltage, the transmittance corresponding to the first gray scale voltage-transmittance curve is lower than the transmittance corresponding to the second gray scale voltage-transmittance curve.

S203: the display period of each frame is divided into a display period and a touch period.

Specifically, the specific embodiment of step S203 can be referred to the related description of step S102 of shown in FIG. 1, and is not mentioned here.

S204: determine the frequency of the touch operation detected by the in-cell touch screen within a predetermined period is less than the first threshold of the frequency, if the judgment result is YES, performing step S205, otherwise performing step S207.

Specifically, if the frequency of the touch operation detected by the in-cell touch screen within a predetermined period is less than the first threshold of the frequency, represented that users performing less touch operation to the in-cell touch screen within a predetermined period. Wherein the first threshold of the frequency within a predetermined period is preset, e.g., the predetermined period mentioned above can be several or dozen frames of the display time; the first threshold of the frequency can be set based on the experience frequency of the user to perform normal touch operation, and can be less than the value of experience.

In some practical embodiments, the current display status of the in-cell touch screen displays is in playing video or playing in full-screen status can also be determined. If yes, it means that users will perform less touch operation to the in-cell touch screen within a predetermined period in the future.

S205: in the display period of each frame, determining a first transmittance according to the first Gamma value corresponding to the Gamma curve, determining the first gray scale voltage according to the first transmittance and the first gray scale voltage-transmittance curve.

If the determination result is YES, means that the in-cell touch screen is mainly used for display within a predetermined period or a period of time in the future, and the gray scale voltage in the display period of the whole frame keeps unchanged. In particular, since the brightness loss of the period mainly used for display caused by leakage is short, the first transmittance can be determined according to the first Gamma value corresponding to the Gamma curve, the first gray scale voltage can be determined according to the first transmittance and the first gray scale voltage-transmittance curve.

S206: input the first gray scale voltage to the data signal line of the in-cell touch screen.

After determining the first gray scale voltage, the register can be set according to the voltage value, the driving device of the in-cell touch screen can output a corresponding first gray scale voltage according to the setting of the register, to makes the transmittance of the in-cell touch screen reach the first transmittance corresponding to the first Gamma value.

S207: determine the frequency of the touch operation detected by the in-cell touch screen within a predetermined period is larger than the second threshold of the frequency, if the judgment result is YES, performing step S208, otherwise performing step S210.

Wherein, if the frequency of the touch operation detected by the in-cell touch screen within a predetermined period is not less than the first threshold of the frequency, it need to be further judge that the frequency is larger than the second threshold of the frequency or not, if the judgment result is YES, it represented that users performing frequently touch operation to the in-cell touch screen within a predetermined period.

If the judgment result is NO, it represented that users performing moderately touch operation to the in-cell touch screen within a predetermined period.

S208: in the display period of each frame, determining a second transmittance according to the second Gamma value corresponding to the Gamma curve, determining the second gray scale voltage according to the second transmittance and the second gray scale voltage-transmittance curve.

If the frequency of the touch operation detected by the in-cell touch screen within a predetermined period is larger than the second threshold of the frequency, it means that users performing frequently touch operation to the in-cell touch screen within a predetermined period, and makes the gray scale voltage keeps unchanged in the display period of the entire display frame. In particular, since the brightness loss of the period caused by leakage when frequently touch is longer, the second transmittance can be determined according to the second Gamma value corresponding to the Gamma curve, the second gray scale voltage can be determined according to the second transmittance and the second gray scale voltage-transmittance curve. Wherein the second transmittance is relatively higher than the first transmittance to compensate the brightness loss of the in-cell touch

S209: input the second gray scale voltage to the data signal line of the in-cell touch screen.

After determining the second gray scale voltage, the register can be set according to the voltage value, the driving device of the in-cell touch screen can output a corresponding second gray scale voltage according to the setting of the register, to makes the transmittance of the in-cell touch screen reach the second transmittance corresponding to the second Gamma value.

S210: in the display period, determining a first gray scale voltage based on the first Gamma value, and input the first gray scale voltage to the data signal line of the in-cell touch screen.

If the frequency of the touch operation detected is between the first threshold of the frequency and the second threshold of the frequency, the transmittance in touch period can be set to higher than the transmittance in display period.

In particular, the particular embodiment to determine the first gray scale voltage based on the first Gamma value, and input the first gray scale voltage to the data signal line of the in-cell touch screen is the same with the particular embodiment shown in steps S205-S206.

S211: in the touch period, determining a second gray scale voltage based on the second Gamma value, and input the second gray scale voltage to the data signal line of the in-cell touch screen.

In particular, the particular embodiment to determine the second gray scale voltage based on the second Gamma value, and input the second gray scale voltage to the data signal line of the in-cell touch screen is the same with the particular embodiment shown in steps S208-S209.

The driving method shown in FIG. 2 can be applied in in-cell touch screen, which includes setting the first Gamma value, the second Gamma value, the first gray scale voltage-transmittance curve and the second gray scale voltage-transmittance curve of the in-cell touch screen; the display period of each frame is divided into a display period and a touch period; determining the gray scale voltage by adaption of the corresponding Gamma value and the gray scale voltage-transmittance curve in the display period and the touch period according to the frequency of the touch operation detected by the in-cell touch screen to control the transmittance of the in-cell touch screen. The present embodiment of the application, the transmittance of the touch period of the in-cell touch screen is higher than the transmittance of the display period of the in-cell touch screen by preset the two sets of Gamma values to compensate for the brightness loss caused by the current leakage in the touch period, and thereby increase the uniformity of the display brightness of the in-cell touch screen and the visual experience.

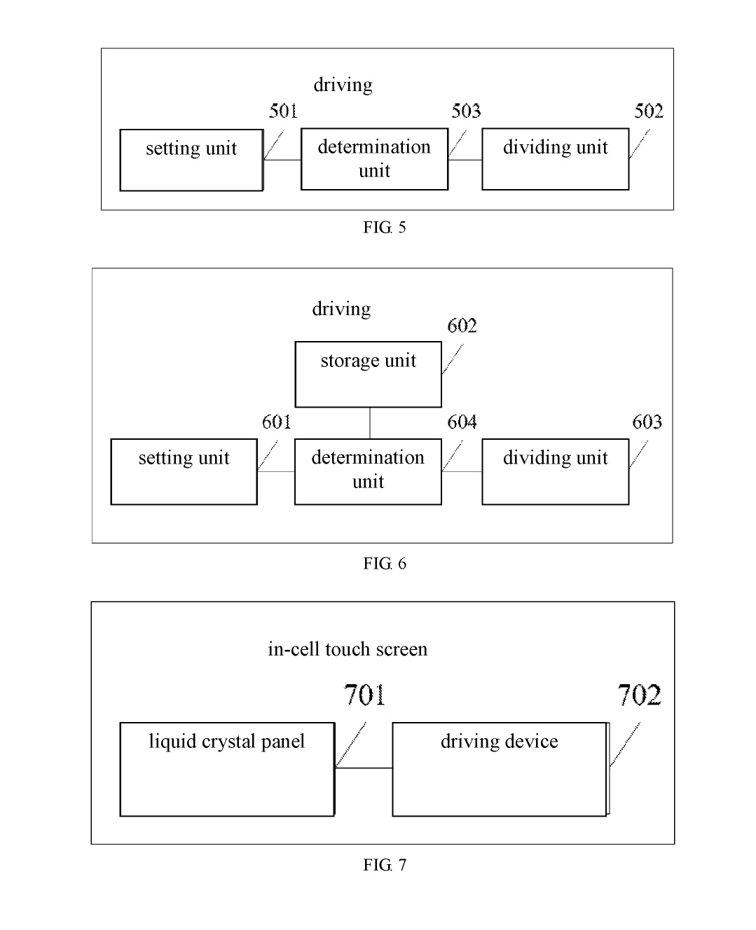

Referring to FIG. 5, is a schematic structure of a driving device according to an embodiment of the present application. As illustrated in FIG. 5, the driving device can include a setting unit 501, a dividing unit 502 and a determination unit 503, wherein:

The setting unit 501 is used for setting the first Gamma value and the second Gamma value of the in-cell touch screen, wherein the first Gamma value is greater than the second Gamma value.

In the particular implementation, the Gamma value of the liquid crystal display is set before leave the factory, each Gamma curve is corresponding to a Gamma curve, the Gamma curve is used to represent non-linear relationship between the level of the gray scale of the liquid crystal display and the transmittance. Wherein, in the same level of the gray scale, the larger the Gamma value, the lower the corresponding transmittance.

In the conventional technology, only a Gamma value is set in the liquid crystal display. In the present embodiment of the application, at least two Gamma values can be set; including the first Gamma value and the second Gamma value, the first Gamma value is greater than the second Gamma value.

As an example, the relationship diagram of the first Gamma value and the second Gamma value separately corresponding to the Gamma curves is illustrated in FIG. 3. As illustrated in FIG. 3, in the same level of the gray scale, the transmittance corresponding to the first Gamma value is lower than the transmittance corresponding to the second Gamma value.

The dividing unit 502 is used to divide the display period of each frame into a display period and a touch period.

In a specific embodiment, in the display period of one frame, the display period is the period to proceed the display scanning; the touch period is the period to proceed the touch scanning. By dividing the display period and the touch period separately at different time periods, can avoid interference between each other.

Alternatively, the display period of one frame can be divided into a set or a plurality set of the display period and the touch period, for example, a display period of one frame can be divided into two sets of display period and touch period including a

display period 1, touch period 1, display period 2, touch period 2. Preferably, the duration of the display period can be greater than the duration of the touch period.

The determination unit 503 is used to determine if the touch operation detected by the in-cell touch screen meets the predetermined condition: in the display period, determining a first gray scale voltage based on the first Gamma value, and input the first gray scale voltage to the data signal line of the in-cell touch screen; in the touch period, determining a second gray scale voltage based on the second Gamma value, and input the second gray scale voltage to the data signal line of the in-cell touch screen.

Alternatively, to meet the predetermined condition can refer to detection the frequency or number of the touch operation within a preset range; or, can refer to detection the scene of the touch operation in a predetermined application scene such as gaming scene, photo shoot scene, text inputting scene and etc.

When the touch operation detected by the in-cell touch screen meets the predetermined condition, the first gray scale voltage can be determined based on the first Gamma value in the display period, and input the first gray scale voltage to the data signal line of the in-cell touch screen. Further, in the display period, a gate scanning signal can also be applied to the gate scanning line of the in-cell touch screen to perform the display scanning.

The second gray scale voltage can be determined based on the second Gamma value in the touch period, and input the second gray scale voltage to the data signal line of the in-cell touch screen. Further, in the touch period, a touch scanning signal can also be applied to the touch scanning line of the in-cell touch screen to perform the touch scanning.

In a specific embodiment, the transmittance of the liquid crystal molecules of the in-cell touch screen is controlled by the gray scale voltage. By controlling the gray scale voltage, the transmittance of the liquid crystal molecules can be achieved corresponding to the transmittance of the Gamma values and the level of the gray scale. In the embodiment of the application, since the first Gamma value is greater than the second Gamma value, when the level of the gray scale is the same, the transmittance corresponding to the second Gamma value is higher than the transmittance corresponding to the first Gamma value. That is, in the display period at the same frame, the transmittance of the touch period is higher than the transmittance of the display period to compensate the brightness loss of the touch period due to the current leakage.

The driving device illustrated in FIG. 5 can be applied in the in-cell touch screen, which can set a first Gamma value and a second Gamma value for the in-cell touch screen, wherein the first Gamma value is greater than the second Gamma value; the display period of each frame is divided into a display period and a touch period; if the touch operation detected by the in-cell touch screen meets the predetermined condition, in the display period, determining a first gray scale voltage based on the first Gamma value, and input the first gray scale voltage to the data signal line of the in-cell touch screen, in the touch period, determining a second gray scale voltage based on the second Gamma value, and input the second gray scale voltage to the data signal line of the in-cell touch screen. By adapting the present embodiment of the application, with the two sets of the predetermined Gamma value makes the transmittance of the touch period is higher than the transmittance of the display period to compensate the brightness loss of the touch period due to the current leakage and thereby increase the uniformity of the display brightness and the visual experience of the in-cell touch screen.

Referring to FIG. 6, is a schematic structure of a driving device according to an embodiment of the present application. As illustrated in FIG. 6, the driving device can include a setting unit 601, a storage unit 602, a dividing unit 603 and a determination unit 604, wherein:

The setting unit 601 is used for setting the first Gamma value and the second Gamma value of the in-cell touch screen, wherein the first Gamma value is greater than the second Gamma value.

In the particular, the specific embodiment of the setting unit 601 can be referring to the related description of the setting unit 501 of the embodiment in FIG. 5, not repeat them here.

The storage unit 602 is used for storing the first gray scale voltage-transmittance curve and the second gray scale voltage-transmittance curve in advance.

Wherein the Gamma value corresponding to the Gamma curve is the relationship curve between the level of the gray scale of the liquid crystal display and the transmittance. The transmittance can be determined according to the level of the gray scale and the Gamma curve. In a specific implementation, the desired transmission can be achieved by applying a suitable gray scale voltage to the data signal line. In the conventional technology, a liquid crystal display just need to set a Gamma value, by storing the Gamma value corresponding to the gray scale voltage-transmittance curve in first, the correct gray scale voltage can be determined.

In the present embodiment of the application, two gray scale voltage-transmittance curves can be stored in advance, including the first gray scale voltage-transmittance curve corresponding to the first Gamma value and a second gray scale voltage-transmittance curve corresponding to the second Gamma value.

As an example, the relationship diagram of the first gray scale voltage-transmittance curve and the second gray scale voltage-transmittance curve can be referred from FIG. 4. As illustrated in FIG. 4, under the same driving voltage, the transmittance corresponding to the first gray scale voltage-transmittance curve is lower than the transmittance corresponding to the second gray scale voltage-transmittance curve.

The dividing unit 603 is used to divide the display period of each frame into a display period and a touch period.

In the particular, the specific embodiment of the dividing unit 603 can be referring to the related description of the dividing unit 502 of the embodiment in FIG. 5, not repeat them here. The determination unit 604 is used to determine if the touch operation detected by the in-cell touch screen meets the predetermined condition: in the display period, determining a first gray scale voltage based on the first Gamma value, and input the first gray scale voltage to the data signal line of the in-cell touch screen; in the touch period, determining a second gray scale voltage based on the second Gamma value, and input the second gray scale voltage to the data signal line of the in-cell touch screen.

In some possible embodiments, a predetermined condition can be met by the frequency of the touch operation detected between the first threshold of the frequency and the second threshold of the frequency. In this time, in the display period, the first transmittance is determined according to the first Gamma value corresponding to the Gamma curve, the first gray scale voltage is determined according to the first transmittance and the first gray scale voltage-transmittance curve. After determining the first gray scale voltage, the register can be set according to the voltage value, the driving device of the in-cell touch screen can output a corresponding first gray scale voltage according to the setting of the register, to makes the transmittance of the in-cell touch screen reach the first transmittance corresponding to the first Gamma value. In the touch period, the second transmittance is determined according to the second Gamma value corresponding to the Gamma curve, the second gray scale voltage is determined according to the second transmittance and the second gray scale voltage-transmittance curve. After determining the second gray scale voltage, the register can be set according to the voltage value, the driving device of the in-cell touch screen can output a corresponding second gray scale voltage according to the setting of the register, to makes the transmittance of the in-cell touch screen reach the second transmittance corresponding to the second Gamma value.

In some possible embodiments, the determination unit 604 is used to:

Within a predetermined period, if the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

Wherein, within a predetermined period, if the frequency of the touch operation detected by the in-cell touch screen is less than the first threshold of the frequency, it means that the in-cell touch screen is mainly used for display within a predetermined period or a period of time in the future, and the gray scale voltage in the display period of the whole frame keeps unchanged. In particular, since the brightness loss of the period mainly used for display caused by leakage is short, the first gray scale voltage can be determined according to the first transmittance, the first gray scale voltage-transmittance curve and the first gray scale voltage can be input to the data signal line of the in-cell touch screen and makes the transmittance of the in-cell touch screen is a relative low first transmittance.

In some possible embodiments, the determination unit 604 is used to:

Within a predetermined period, if the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

Wherein, if the frequency of the touch operation detected by the in-cell touch screen is larger than the second threshold of the frequency, it means that users performing frequently touch operation to the in-cell touch screen within a predetermined period, and makes the gray scale voltage keeps unchanged in the display period of the entire display frame. In particular, since the brightness loss of the period caused by leakage when frequently touch is longer, the second gray scale voltage can be determined according to the second transmittance and the second gray scale voltage-transmittance curve, the second gray scale voltage can be input to the data signal line of the in-cell touch screen and makes the transmittance of the in-cell touch screen is a relative high first transmittance.

The driving device illustrated in FIG. 6 can be applied in the in-cell touch screen, which can set the first Gamma value, the second Gamma value, the first gray scale voltage-transmittance curve, and the second gray scale voltage-transmittance curve for the in-cell touch screen; the display period of each frame is divided into a display period and a touch period; determining the gray scale voltage by adaption of the corresponding Gamma value and the gray scale voltage-transmittance curve in the display period and the touch period according to the frequency of the touch operation detected by the in-cell touch screen to control the transmittance of the in-cell touch screen. The present embodiment of the application, the transmittance of the touch period of the in-cell touch screen is higher than the transmittance of the display period of the in-cell touch screen by preset the two sets of Gamma values to compensate for the brightness loss caused by the current leakage in the touch period, and thereby increase the uniformity of the display brightness of the in-cell touch screen and the visual experience.

Referring to FIG. 7, FIG. 7 is a schematic structure of an in-cell touch screen according to an embodiment of the present application. As shown in FIG. 7, the driving device can include a liquid crystal panel 701 and the driving device 702, wherein the driving device 702 can be the driving device described in FIG. 5 or 6.

According to the related description of the embodiments shown in FIG. 5 or 6, the transmittance of the touch period of the in-cell touch screen is higher than the transmittance of the display period of the in-cell touch screen by preset the two sets of Gamma values to compensate for the brightness loss caused by the current leakage in the touch period, and thereby increase the uniformity of the display brightness of the in-cell touch screen and the visual experience.

The modules or units in the embodiment of the present application can be achieved by a universal integrated circuit, for example, Central Processing Unit, CPU, or by Application Specific Integrated Circuit, ASIC.

The order of the steps in the methods in the embodiment of the present application can be adjusted, merging and deletion according to actual needs.

The units in the embodiment of the present application can be combined, division or exclusion according to actual needs.

The person having ordinary skill in the art will be appreciated that all or part of the process in the method of the embodiments above, can be achieved through a computer program to instruct the relevant hardware, the program can be stored in a computer readable storage medium, when executing the program, the steps of the method as described above for each embodiment can be included. Wherein the storage medium can be a disk, an optical disk, a Read-Only Memory, ROM, or a Random Access Memory, RAM and the like.

Above are embodiments of the present application, which does not limit the scope of the present application. Any modifications, equivalent replacements or improvements within the spirit and principles of the embodiment described above should be covered by the protected scope of the invention.

What is claimed is:

1. A driving method, applied in an in-cell touch screen, wherein the driving method comprising:
setting a first Gamma value and a second Gamma value of the in-cell touch screen, wherein the first Gamma value is greater than the second Gamma value;
dividing the display period of each frame into a display period and a touch period;
if the touch operation detected by the in-cell touch screen meets the predetermined condition:
in the display period, determining a first gray scale voltage based on the first Gamma value, and input the first gray scale voltage to a data signal line of the in-cell touch screen; and
in the touch period, determining a second gray scale voltage based on the second Gamma value, and input the second gray scale voltage to the data signal line of the in-cell touch screen.

2. The driving method according to claim 1, wherein the predetermined condition comprising:
within a predetermined period, the frequency of the touch operation detected by the in-cell touch screen is between the first threshold of the frequency and the second threshold of the frequency, wherein the first threshold of the frequency is less than the second threshold of the frequency.

3. The driving method according to claim 2, wherein the driving method further comprising:
within a predetermined period, the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

4. The driving method according to claim 2, wherein the driving method further comprising:
within a predetermined period, the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

5. The driving method according to claim 1, wherein the driving method further comprising:
storing the first gray scale voltage-transmittance curve and the second gray scale voltage-transmittance curve in advance;
determining the first gray scale voltage according to the first Gamma value, the specific is:
determining the first transmittance according to the first Gamma value corresponding to the Gamma curve, and determining the first gray scale voltage according to the first transmittance and the first gray scale voltage-transmittance curve; and
determining the second gray scale voltage according to the second Gamma value, the specific is:
determining the second transmittance according to the second Gamma value corresponding to the Gamma curve, and determining the second gray scale voltage according to the second transmittance and the second gray scale voltage-transmittance curve.

6. A driving device, applied in an in-cell touch screen, wherein the driving device comprising:
a setting unit, used for setting a first Gamma value and a second Gamma value of the in-cell touch screen, wherein the first Gamma value is greater than the second Gamma value;
a dividing unit, used to divide the display period of each frame into a display period and a touch period;
a determination unit, used to determine if the touch operation detected by the in-cell touch screen meets the predetermined condition:
in the display period, determining a first gray scale voltage based on the first Gamma value, and input the first gray scale voltage to a data signal line of the in-cell touch screen; and
in the touch period, determining a second gray scale voltage based on the second Gamma value, and input the second gray scale voltage to the data signal line of the in-cell touch screen.

7. The driving device according to claim 6, wherein the predetermined condition comprising:
within a predetermined period, the frequency of the touch operation detected by the in-cell touch screen is between the first threshold of the frequency and the second threshold of the frequency, wherein the first threshold of the frequency is less than the second threshold of the frequency.

8. The driving device according to claim 7, wherein the determination unit is further used for:
within a predetermined period, the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

9. The driving device according to claim 7, wherein the determination unit is further used for:
within a predetermined period, the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

10. The driving device according to claim 6, wherein the driving device further comprising:
a storage unit used for storing the first gray scale voltage-transmittance curve and the second gray scale voltage-transmittance curve in advance; and
the determination unit is specific used to determine the first transmittance according to the first Gamma value corresponding to the Gamma curve, determining the first gray scale voltage according to the first transmittance and the first gray scale voltage-transmittance curve; or
determine the second transmittance according to the second Gamma value corresponding to the Gamma curve, determining the second gray scale voltage according to the second transmittance and the second gray scale voltage-transmittance curve.

11. An in-cell touch screen, wherein the in-cell touch screen comprising a liquid crystal panel and a driving device, wherein the driving device comprising:
a setting unit, used for setting a first Gamma value and a second Gamma value of the in-cell touch screen, wherein the first Gamma value is greater than the second Gamma value;
a dividing unit, used to divide the display period of each frame into a display period and a touch period;
a determination unit, used to determine if the touch operation detected by the in-cell touch screen meets the predetermined condition:
in the display period, determining a first gray scale voltage based on the first Gamma value, and input the first gray scale voltage to a data signal line of the in-cell touch screen; and
in the touch period, determining a second gray scale voltage based on the second Gamma value, and input the second gray scale voltage to the data signal line of the in-cell touch screen.

12. The in-cell touch screen according to claim 11, wherein the predetermined condition comprising:
within a predetermined period, the frequency of the touch operation detected by the in-cell touch screen is between the first threshold of the frequency and the second threshold of the frequency, wherein the first threshold of the frequency is less than the second threshold of the frequency.

13. The in-cell touch screen according to claim 12, wherein the determination unit is further used for:
within a predetermined period, the frequency of the touch operation detected by the in-cell touch screen is less than the first threshold of the frequency, in the display period of each frame, a first gray scale voltage is determined according to the first Gamma value, and input the first gray scale voltage to the data signal line of the in-cell touch screen.

14. The in-cell touch screen according to claim 12, wherein the determination unit is further used for:
within a predetermined period, the frequency of the touch operation detected by the in-cell touch screen is larger than the second threshold of the frequency, in the display period of each frame, a second gray scale voltage is determined according to the second Gamma value, and input the second gray scale voltage to the data signal line of the in-cell touch screen.

15. The in-cell touch screen according to claim 11, wherein the driving device further comprising:
a storage unit used for storing the first gray scale voltage-transmittance curve and the second gray scale voltage-transmittance curve in advance; and
the determination unit is specific used to determine the first transmittance according to the first Gamma value corresponding to the Gamma curve, determining the first gray scale voltage according to the first transmittance and the first gray scale voltage-transmittance curve; or
determine the second transmittance according to the second Gamma value corresponding to the Gamma curve, determining the second gray scale voltage according to the second transmittance and the second gray scale voltage-transmittance curve.
